(19) United States
(12) Patent Application Publication
(10) Pub. No.: US 2015/0371290 A1
(43) Pub. Date: Dec. 24, 2015

(54) METHOD OF CORRELATING HUMAN ACTIVITIES WITH THIRD PARTY DONATIONS

(71) Applicant: Douglas Hexter, Trumansburg, NY (US)

(72) Inventor: Douglas Hexter, Trumansburg, NY (US)

(21) Appl. No.: 14/742,742

(22) Filed: Jun. 18, 2015

Related U.S. Application Data
(60) Provisional application No. 62/014,308, filed on Jun. 19, 2014.

(51) Int. Cl. G06Q 30/02

(52) U.S. Cl. CPC G06Q 30/0279

(57) ABSTRACT

A method of correlating human activities with third-party donations. A participant downloads an app and enrolls on a web site. The app assigns a human activity to the participant. The app quantifies and monitors the human activity. A commitment is received from a third-party sponsor to donate things of value to an organization that controls the app-based system, the controlling organization, in turn, making a contribution to a predetermined charitable business, preferably a 501(c)(3) organization, such as a shelter and/or rescue organization. The charitable business receives contributions from the controlling organization dependent on performance of the participant's human activity.

### RELATED PATENT APPLICATION

The present application is related to U.S. Provision Patent Application No. 62/014,308, filed Jun. 19, 2014 for METHOD OF CORRELATING HUMAN ACTIVITIES WITH THIRD PARTY DONATIONS and hereby incorporates the teachings therein in their entirety.

### FIELD OF THE INVENTION

This invention relates to methods of monitoring human activities and, in particular, to a method of correlating human activities with third-party donations to charitable organizations.

### BACKGROUND OF THE INVENTION

Citizens of the United States are considered some of the most benevolent in the world. The Internal Revenue Service encourages private contributions and donations by establishing so-called tax-exempt organizations under section 501(c)(3) of the Internal Revenue Code. Individuals and corporations that donate to such 501(c)(3) tax-exempt organizations may deduct their contributions on their tax returns, so that their reportable, taxable income is decreased. To be tax exempt, an organization must be organized and operated exclusively for exempt purposes. None of its earnings may inure to any private shareholder or individual. In addition, it may not be an action organization. It may not attempt to influence legislation as a substantial part of its activities and it may not participate in any campaign activity for or against political candidates. The organization must not be organized or operated for the benefit of private interests.

In 2014, some 60% of Americans donated $258 billion to 501(c)(3) organizations. Organizations are routinely established in America to help domestic and foreign victims of floods, earthquakes, fires, other natural disasters, and epidemics.

The victims of disasters are not limited to humans. Animals are often injured by natural disasters or abuse. Some 14,000 animal shelter/rescue locations are in the country. Pet owners are generally appreciative of the work that such shelter/rescue organizations provide. In fact, over 56 million households in the U.S. are estimated to have dogs. While many of such pet owners donate time or money or things of value to their local shelter/rescue organizations, others are either ignorant of the existence of such organizations and their needs or are financially unable to make donations.

Certain companies are also ready, willing, and able to make cash donations or to contribute things of value to needy, local organizations, but lack a standardized mechanism for doing so. Consequently, such companies may contribute to worthy organizations nationally, but funds may be greatly diluted by the time they reach the local organizations in greatest need. Since the middle of the last century, matching corporate grants have been made by larger companies for their employees on a 1:1 or even 2:1 basis, but again, the employees must know of specific organizations to which their donations are to be made.

The present invention provides a mechanism by which concerned citizens can identify an organization (e.g., a shelter or rescue) and channel third-party funds to those organizations based on physical activities performed by the citizens. As the system's user base grows, increased donations are made to shelters/rescues and sponsors realize increased marketing through advertisements.

### DESCRIPTION OF RELATED ART

U.S. Pat. No. 8,666,799 issued to Good, et al. for SYSTEM AND METHOD FOR GENERATING A COMMUNITY CONTRIBUTION INDEX issued on Mar. 4, 2014, describes a system and method for generating a community contribution index (CCI) for organizations and providing reports pertaining to the CCI for one or more organizations. The CCI for an organization is calculated based upon monetary donations provided by the organization and the members associated with the organization and the number of volunteer hours provided by the members. The CCI provides a standardized way to measure an organization's contributions to the community.

U.S. Pat. No. 8,494,913 issued to Cavagnaro for MULTI-PARTY PAYMENT OBJECT ORIENTED SYSTEM AND METHOD issued on Jul. 23, 2013, describes a server for accommodating multiple e-commerce payments. The server includes a processor with a communications device and software modules. The vendor software module receives payment requirements from a vendor, and also receives payment parameters from an initiator. The payment parameters include an item payment amount and an identification of contributors. The contributor software module obtains payment information from the initiator and/or contributors sufficient to authorize the commitment of funds to a transaction. The aggregation software module sends participation messages to contributors. The participation messages include information on the item, the item payment amount, and directions for the contributor to interact with the contributor module. Further, the aggregation software module maintains a total of committed funds and initiates a payment transaction when the committed funds are sufficient to pay the vendor.

U.S. Pat. No. 8,473,421 issued to Scalisi for SYSTEMS AND METHODS FOR FUNDRAISING VIA MOBILE APPLICATIONS issued on Jun. 25, 2013, describes methods and systems of facilitating a transfer of donation money from individuals to charitable organizations. The transfer of money occurs through a first transfer of money from at least one mobile phone carrier to a facilitating organization and through a second transfer of money from the facilitating organization to the charitable organization. The facilitating organization enables the money transfer by transmitting web-based and mobile phone communications regarding donations on behalf of charitable organizations and enabling individuals to respond to such communications and communicate donation solicitations to other individuals.

### SUMMARY OF THE INVENTION

In accordance with the present invention, there is provided a method of correlating human activities with third-party donations. A participant enrolls on a web site. A mobile application (app) is downloaded by a participant, the app assigning a human activity (e.g., walking, running, bicycling, swimming, climbing, etc.) to the participant. The app quantifies and monitors the human activity. A commitment is received from a third-party sponsor to donate things of value (e.g., cash) to an organization, preferably a 501(c)(3) organization, that controls the system, the controlling organization, in turn, making a contribution to a predetermined charitable business, such as a shelter and rescue organization. The charitable business receives contributions from the controlling organization dependent on performance of the human activity.

It is therefore an object of the invention to provide an incentive for participants to engage in physical activities.

It is a further object of the present invention to provide a method to aid sponsors in publicizing their commitment to socially responsible activities.

It is a further object of the present invention to provide a method to increase income to socially responsible charitable businesses, such as a shelter and rescue organization.

It is yet a further object of the present invention to allow participants to cause contributions to be made on their behalf to socially responsible charitable businesses on an automatic or semi-automatic basis.

These and other objects and advantages of the present invention are more readily apparent with reference to the following detailed description and the accompanying drawings.

### BRIEF DESCRIPTION OF THE DRAWINGS

A complete understanding of the present invention may be obtained by reference to the accompanying drawings, when considered in conjunction with the subsequent detailed description, in which:

FIG. 1 is a flow chart of business operations in accordance with the present invention;

FIG. 2 is a flow chart of mobile application (“app”) operations in accordance with the present invention; and

FIG. 3 is a set of annotated display screens to illustrate the steps a participant performs when executing the app depicted in FIG. 2.

### DETAILED DESCRIPTION OF THE PREFERRED EMBODIMENT

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

The present invention is a method of correlating human activities with third-party donations. A system quantifies and monitors a human activity. A commitment is received from a third-party sponsor to donate things of value to an organization, preferably a 501(c)(3) organization, that controls the system, the controlling organization, in turn, making a contribution to a predetermined charitable business.

The inventive system is a profit venture funded by sponsor-based advertising. A mobile application (app) can be downloaded to a Smart Phone, iPhone, and Android operating systems or any personal digital assistant, such as an iPad, a laptop, or even a desktop computer. The app is used to record a user's activities (e.g., dog walk data) and from that, receives payments from one or more sponsors, a controlling organization donating accordingly to user-specified charitable organizations. The user or participant can be an individual, a group, a team, a company department, or a community. In essence, the inventive system enables the sponsorship of people walking their dogs, for example. An incentive is provided participants. For every mile a user walks his dog, for example, a donation is made by the controlling organization to a user-specified animal organization. The invention promotes healthy pets and healthy humans while raising money to support local animal shelters.

After the app is downloaded by a participant to his phone, for example, the participant takes the phone with him when he walks his dog. Simply pressing the “start” button activates the app to keep track of all walks.

The coordinating organization that controls the inventive system sends money to active shelters and rescues about three times per year. Donations are based on the number of people walking for a specified charitable organization and the total miles walked. The amount per mile donated varies based on certain factors.

The invention provides a way to keep track of the participants' walks or other physical activities, encouraging them to walk more with their dog every day, for example. Participants also have the satisfaction of knowing that their dog walking directly benefits their local shelter. Participants may also receive special offers from the sponsors.

The invention promotes interactions between pets and their owners and raises money to support the charitable organization's mission. Participants have a reason to think about their local shelter or rescue organization every time they take their dogs for a walk.

Sponsors can reach a receptive audience of dedicated dog owners. By sponsoring the app, businesses show their support for local animal organizations, and supporting healthy activity in the community.

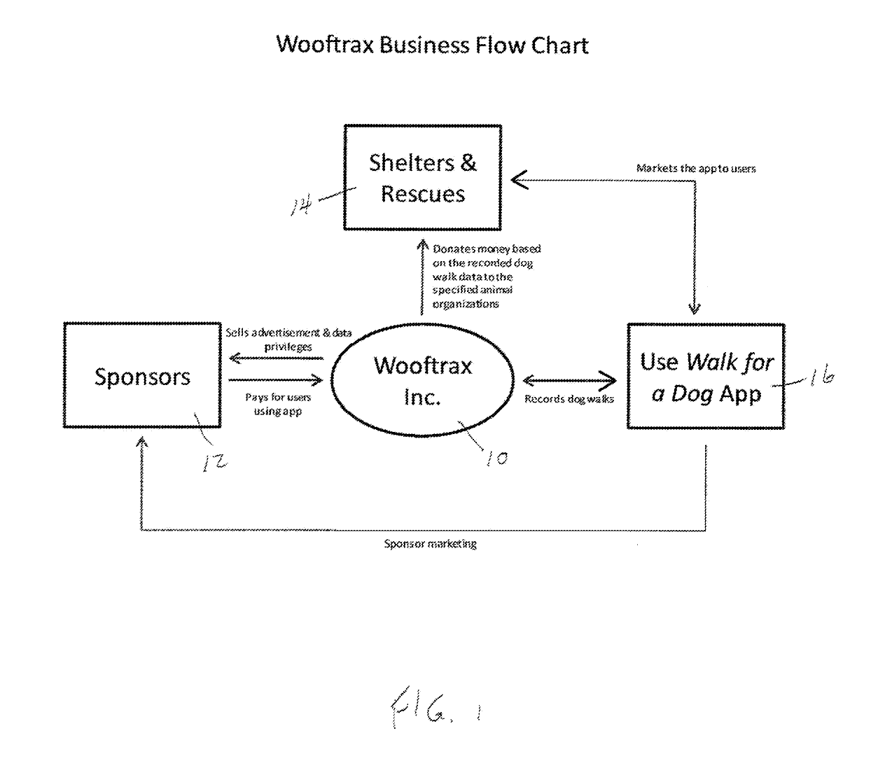

Referring now to FIG. 1, there is shown a flow chart of business operations in accordance with the present invention. A controlling organization 10 communicates bilaterally with one or more sponsors 12, each of which purchases advertisements from and provides other promotional considerations to controlling organization 10. Sponsors 12 are generally commercial entities that may offer goods or services relating to subject matter of interest to participants, not shown, who use an app created and distributed by controlling organization 10. For example, when an app encourages participants to walk their dog, suitable sponsors 12 may include, but not be limited to pet food or pet clothing companies. Certain data collected via the app by controlling organization 10 can be used by sponsors 12 to target their advertising messages. For example, a particular pet vitamin manufacturer may wish to promote its joint relief vitamins to large breed dog owners residing a specific region of the country whose dogs are at least a certain age. Sponsors 12 may commit to paying controlling organization 10 a fixed sum per month or a fixed fee per mile walked by all participants.

Also in communicative relationship with controlling organization 10 is a plurality of charitable businesses 14, such as, but not limited to, not-for-profit groups and agencies engaged in sheltering or rescuing animals and/or people (e.g., pet shelters, disaster relief organizations, etc.). Charitable businesses 14 may receive single or recurring donations from controlling organization 10, pursuant to the policy thereof, as described hereinbelow.

The app 16 used by a plurality of participants is in communicative relationship with: a) controlling organization 10, recording participant activities and transmitting same to controlling organization 10; b) sponsors 12 that advertise for the benefit of participants; and c) charitable organizations 14, preferably 501(c)(3) companies, that receive contributions from controlling organization 10 pursuant to activities performed by participants.

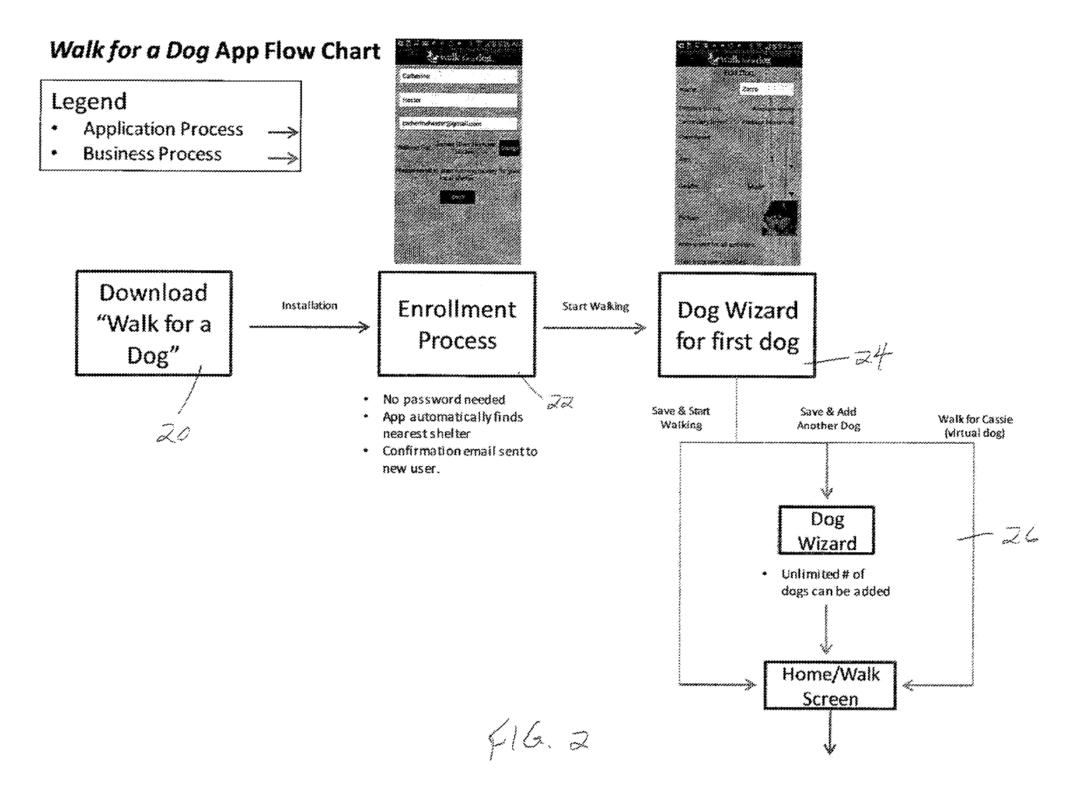

Referring now also to FIG. 2, there is shown a flow chart of app operations. A participant first downloads an app, step 20, for a particular physical activity to benefit particular charitable organizations 14 (FIG. 1). The participant enrolls in the program, step 22, which may identify a local charitable organization 14 that meets the participant's desires or profile. No password is required to enroll in the preferred embodiment. The app may automatically identify the closest local charitable organization 14 (FIG. 1) to the participant's location. After the participant's email address is verified, a confirmation email is sent thereto from the controlling organization 10 upon successful enrollment.

A subroutine is executed, step 24, once the participant engages in and records his physical activity. In the case of performing more than one physical activity or walking an additional dog, for example, repetitive activities can be prompted to the participant and handled by the app, step 26. For participants who do not have a dog or who are not performing an activity with a dog, a virtual proxy shelter dog named Cassie can be selected by the participant.

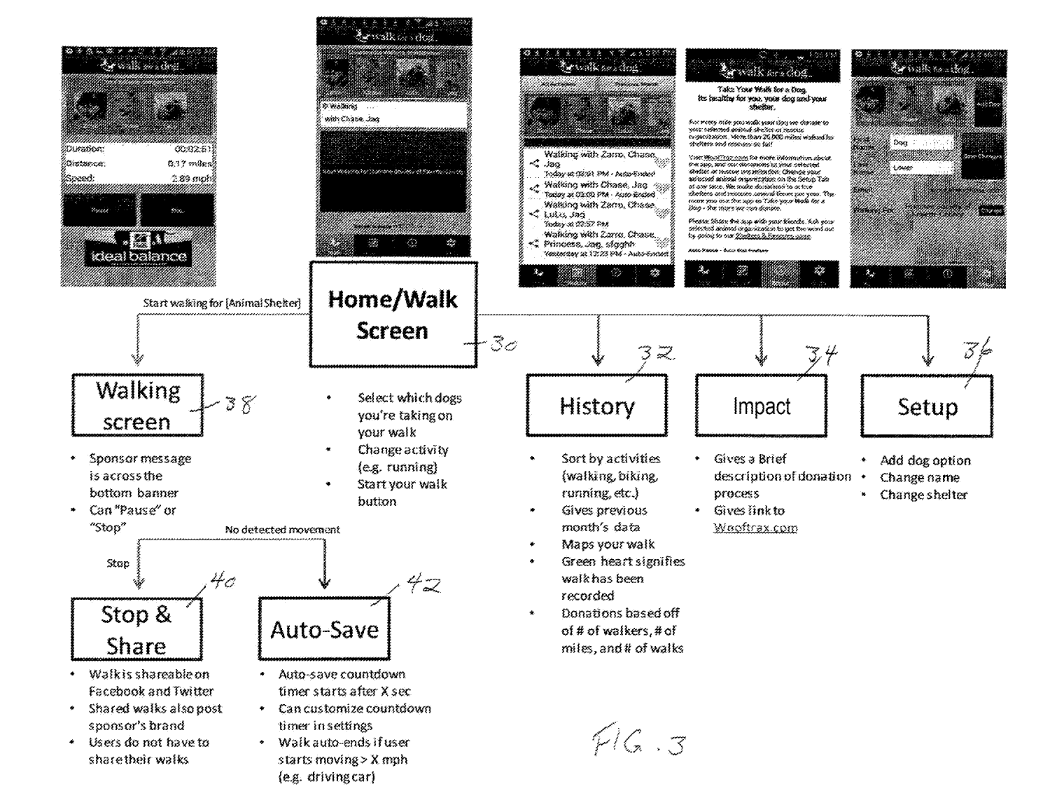

Referring now also to FIG. 3, there is shown a set of representative annotated display screens to illustrate the steps a participant performs when executing the app depicted in FIG. 2. For purposes of description herein, dog-walking activities are illustrated, but it should be understood that any one of a number of physical activities (e.g., walking, running, exercising, participating in group or individual athletic events, etc.) can be monitored without departing from the scope of the invention. Likewise, although five screens are shown in this FIG. 3, it should be understood that any number of display screens can be used depending on criteria and policies implemented by controlling organization 10 (FIG. 1).

A HOME screen 30 displays the names of the dogs being taken for a walk by a participant. HOME screen 30 may allow a participant to select other physical activities and may include a START button or icon to begin monitoring any activity. Once a dog or dogs have been selected by the participant and the START button has been pressed, one or more sponsor messages are displayed to the participant.

A HISTORY screen 32 of a participant's activities can be accessed from HOME screen 30. Such history screen can include activities sorted by any suitable criteria, including statistics that show dates of completion, graphical representations of maps of recent walking paths, and cumulative donations made to charitable organizations 14 (FIG. 1) based on the number of participant walkers, the number of walks completed, the total number of miles walked, etc. The HISTORY screen 32 can be used to display current and ongoing activities of the participant, such as duration of the activity, distance traveled, and speed in miles per hour. An advertisement or logo for one or more sponsors can be displayed on this active display. An icon such as a heart symbol [symbol] or +, −, [symbol] , →, ∘ and can be displayed on the HISTORY screen to indicate a participant's activity has been recorded for his designated charitable organization 14 (FIG. 1).

An IMPACT screen 34 can display a description of the donation process and can provide a link to the web site of controlling organization 10 (FIG. 1).

A SETUP screen 36 is used to allow a participant to add dogs or activities to the program, to change the name of the activity, and to change the identity of the charitable organization 14 (FIG. 1) to which the participant's activities are applied.

Once an activity is halted, active execution of the app is suspended. The participant may report his activities, step 40, on a social medium to which he belongs, such as Facebook or Twitter. Such reporting of activities may include a display of advertisements or offers by a sponsor 12 (FIG. 1) or a reference thereto. Moreover, an auto-save function of the app 42 can display a countdown value of seconds or minutes to indicate a predetermined time has elapsed. Such countdown function can be programmed by the participant in the SETUP screen 36. Once the participant resumes activity, the app senses motion and execution of the app continues. To prevent fraud, the app senses extreme movement, such as in a car, bus, or train, and ceases execution of the program. If the participant drives home from a dog walk, only the walking portion of the activity is saved.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention. For example, the physical activity performed by participants may include, but not be limited to, walking, running, exercising, participating in group or individual athletic events, etc. Moreover, the device on which such activity is recorded can include, but not be limited to, Smart Phones, iPhones, iPads, personal digital devices (PDAs), laptops, desktops, etc. In addition, payments from may include, but not be limited to, cash, in-kind services, gift cards, subscriptions, stock, and other things of value.

Having thus described the invention, what is desired to be protected by Letters Patent is presented in the subsequently appended claims.

What is claimed is:

1. A method of correlating human activities with third party donations, the steps comprising:
a) distributing an app to at least one potential participant;
b) enrolling a participant in an incentive program;
c) assigning a human activity to said participant;
d) quantifying said human activity;
e) receiving from a third-party sponsor a payment to said controlling organization based upon said quantifying step (d); and
f) transferring at least a portion of said payment to a predetermined charitable business dependent on performance of said human activity.

2. The method of correlating human activities with third party donations in accordance with claim 1, wherein said distributing step (a) is performed by a controlling organization.

3. The method of correlating human activities with third party donations in accordance with claim 1, wherein said enrolling step (b) is accomplished by means of a web site.

4. The method of correlating human activities with third party donations in accordance with claim 1, wherein said human activity comprises at least one of the following activities: walking, running, exercising, and participating in group or individual athletic events.

5. The method of correlating human activities with third party donations in accordance with claim 2, wherein said payment from said third-party sponsor comprises at least one of the following: cash, in-kind services, gift cards, subscriptions, stock, and other things of value.

6. The method of correlating human activities with third party donations in accordance with claim 1, wherein said participant comprises at least one of: an individual, a group, a team, a company department, and a community.

7. The method of correlating human activities with third party donations in accordance with claim 4, wherein said quantifying step (d) further comprises monitoring said human activity.

8. The method of correlating human activities with third party donations in accordance with claim 1, wherein said predetermined charitable business comprises a 501(c)(3) company.

9. The method of correlating human activities with third party donations in accordance with claim 1, wherein said receiving and transferring steps (e) and (f), respectively, are performed automatically.

10. The method of correlating human activities with third party donations in accordance with claim 6, the steps further comprising automatically identifying the closest predetermined charitable business to the location of said participant.

11. The method of correlating human activities with third party donations in accordance with claim 1, the steps further comprising displaying a sponsor message to said participant.

12. The method of correlating human activities with third party donations in accordance with claim 4, the steps further comprising providing said participant with a history of a participant's activities.

13. The method of correlating human activities with third party donations in accordance with claim 12, the steps further comprising displaying an icon to annotate said history of activities, to indicate a specified activity has been recorded for said predetermined charitable business, said icon comprising at least one of the symbols: +, −, [symbol] , →, ∘ and .

14. The method of correlating human activities with third party donations in accordance with claim 2, the steps further comprising providing said participant with a link to a web site of said controlling organization.

15. The method of correlating human activities with third party donations in accordance with claim 3, the steps further comprising sending a confirmation email to said participant after performing said enrolling step (b).

16. A method of correlating human activities with third party donations, the steps comprising:
a) assigning a human activity to a participant;
b) quantifying said human activity;
c) receiving from a third-party sponsor a payment to a controlling organization based upon said quantifying step (b); and
d) transferring at least a portion of said payment to a predetermined charitable business dependent on performance of said human activity.

17. The method of correlating human activities with third party donations in accordance with claim 16, wherein said method is performed by a controlling organization.

18. The method of correlating human activities with third party donations in accordance with claim 17, wherein said human activity comprises at least one of the following activities: walking, running, exercising, and participating in group or individual athletic events, and wherein said payment from said third-party sponsor comprises at least one of the following: cash, in-kind services, gift cards, subscriptions, stock, and other things of value.

19. The method of correlating human activities with third party donations in accordance with claim 16, wherein said quantifying step (b) further comprises monitoring said human activity.

20. The method of correlating human activities with third party donations in accordance with claim 16, wherein said receiving and transferring steps (c) and (d), respectively, are performed automatically.
